(19) United States
(12) Patent Application Publication
(10) Pub. No.: US 2017/0140395 A1
(43) Pub. Date: May 18, 2017

(54) SELLING STATUS DISPLAY METHOD, SELLING STATUS DISPLAY APPARATUS, AND RECORDING MEDIUM

(71) Applicant: FUJITSU LIMITED, Kawasaki-shi (JP)

(72) Inventor: Kunie Doi, Oota (JP)

(21) Appl. No.: 15/337,734

(22) Filed: Oct. 28, 2016

(30) Foreign Application Priority Data
Nov. 16, 2015 (JP) 2015-223898

(51) Int. Cl. G06Q 30/02; G06F 3/14; G06T 11/20

(52) U.S. Cl. CPC G06Q 30/0201; G06T 11/206; G06F 3/1454

(57) ABSTRACT

A selling status display method including specifying, by a computer when a first graph representing a selling status at each store or a variation in sales among stores is generated and displayed with regard to a designated item, an item category to which the designated item belongs generating, by the computer, a second graph representing a selling status at each store or a variation in sales among stores with regard to the specified item category; and simultaneously displaying, by the computer, the second graph and the first graph.

### CROSS REFERENCE TO RELATED APPLICATIONS

This application is based upon and claims the benefit of priority of the prior Japanese Patent Application No. 2015-223898, filed on Nov. 16, 2015, the entire contents of which are incorporated herein by reference.

### FIELD

The embodiments discussed herein relate to a selling status display method, a selling status display apparatus, and a recording medium.

### BACKGROUND

In companies operating multiple stores, it is important to ascertain the selling status of items at the respective stores. For example, with regard to a certain item, the selling status thereof may vary among the stores. In this case, for example, the sale of stock may be facilitated by conducting so-called inter-store transfer, which is a method of transferring items from a store where the number of items sold is small and the number of items in stock is large to another store where the number of items sold is large and the number of items in stock is small.

As a conventional technique, for example, there is a technique in which recombination of item attributes set for respective hierarchies in attribute hierarchies used for attribute hierarchy analysis may be made, and when the item attributes are recombined, data aggregation according to the changed attribute hierarchies is performed. For example, refer to Japanese Laid Open Patent Publication No. H11-238048.

### SUMMARY

According to an aspect of an embodiment, a selling status display method including specifying, by a computer when a first graph representing a selling status at each store or a variation in sales among stores is generated and displayed with regard to a designated item, an item category to which the designated item belongs generating, by the computer, a second graph representing a selling status at each store or a variation in sales among stores with regard to the specified item category; and simultaneously displaying, by the computer, the second graph and the first graph.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of a selling status display method according to an embodiment;

FIG. 2 is an explanatory diagram depicting a system configuration example of a business support system 200;

FIG. 3 is a block diagram of hardware configuration of a selling status display apparatus 100;

FIG. 4 is a block diagram of hardware configuration of a client apparatus 201;

FIG. 5 is an explanatory diagram depicting an example of storage contents of an item attribute table 500;

FIG. 6 is an explanatory diagram depicting an example of storage contents of a store consumption rate table 600;

FIG. 7 is an explanatory diagram depicting a screen example of an item-attribute selection screen 700;

FIG. 8 is a block diagram depicting a functional configuration example of the selling status display apparatus 100;

FIG. 9 is an explanatory diagram depicting a screen example of a weekly MD analysis screen 900;

FIG. 10 is an explanatory diagram depicting a screen example of a store consumption rate analysis screen 1000;

FIG. 11 is an explanatory diagram depicting a screen example of a cumulative performance screen 1100;

FIG. 12 is a flowchart depicting an example of a selling-status display process procedure of the selling status display apparatus 100;

FIG. 13 is a flowchart depicting an example of a specific process procedure of a weekly MD analysis-screen displaying process;

FIG. 14 is a flowchart depicting an example of a specific process procedure of a store consumption rate analysis screen displaying process; and

FIG. 15 is a flowchart depicting an example of a specific process procedure of a cumulative performance screen displaying process.

### DESCRIPTION OF THE INVENTION

Embodiments of a selling status display method, a selling status display apparatus, and a recording medium will be described in detail with reference to the accompanying drawings.

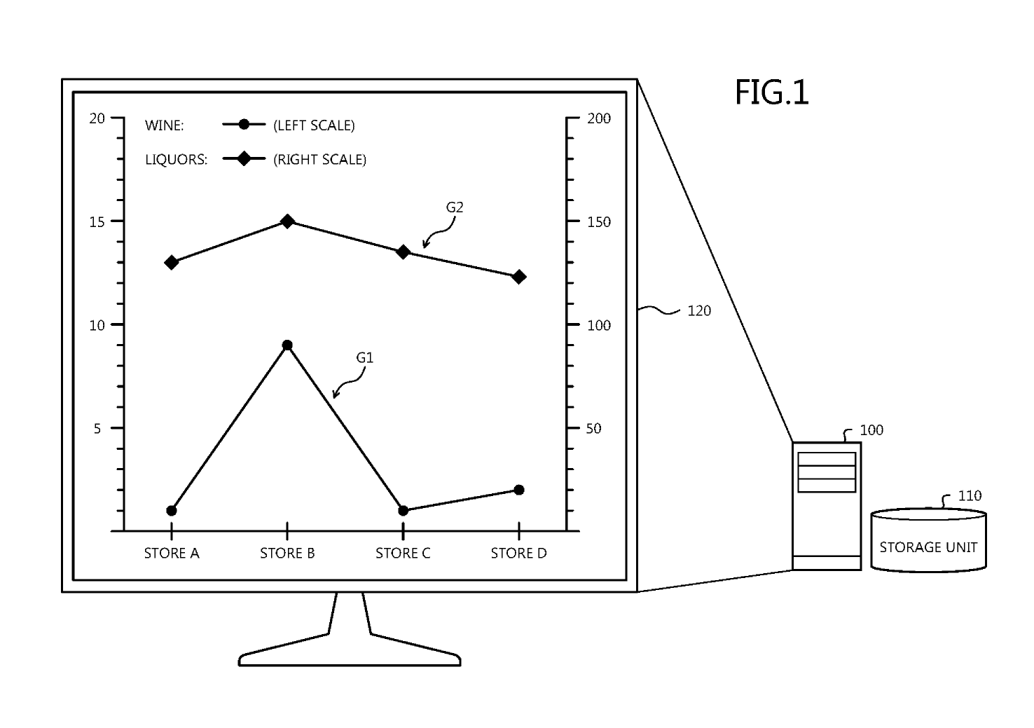

FIG. 1 is an explanatory diagram depicting an example of a selling status display method according to an embodiment. In FIG. 1, a selling status display apparatus 100 is a computer that supports ascertaining the selling status of each item at respective stores. The stores are facilities for selling items, and are a clothes store, a clothing store, a department store, a supermarket, and a restaurant, for example. The items are goods sold at the stores, and are clothes, furnishings, general merchandise, food, and drinks, for example.

At companies and the like that operate multiple stores, it is important to ascertain the selling status of items at the respective stores. For example, the sale of stock may be facilitated by determining variation in sales among the stores and the sales performances at all stores and then conducting operations such as inter-store transfer and changing selling prices, based on the selling status of items at the respective stores.

The selling status of items at respective stores may be determined by checking the number of items received, the number of sales, the number of items in stock, and the like at the respective stores, for example. However, when the number of operated stores is large and the number of items being sold at the respective stores is also large, it takes much time and labor to check the number of items received, the number of sales, and the number of items in stock for each item at respective stores in order to ascertain the selling status of each item at the respective stores.

In the present embodiment, a selling status display method is described for facilitating ascertaining the selling status of each item at each store. A processing example of the selling status display apparatus 100 is described below.

(1) The selling status display apparatus 100 generates a first graph representing the selling status at each store or variation in sales among stores with regard to a designated item. For example, the designated item is, among the items being sold at multiple stores, an item handled as an analyzing subject of the selling status at respective stores. For example, the designation of the item is performed by a user operation input.

In particular, for example, the selling status display apparatus 100 may be configured to generate a first graph representing the number of sales at each store with regard to a designated item. The number of sales is the number of items sold at the store. Thus, with regard to the designated item, it is possible to generate a graph with which the selling status at each store may be determined based on the number of sales at respective stores.

Furthermore, as for a designated item, there is a case where the number of items received at respective stores is different among these stores. The number of items received is the number of items received at these stores. In this case, it is difficult to relatively evaluate the selling status at each store based only on the number of sales at each of the stores. That is, it is difficult to determine variation in sales among these stores.

Therefore, for example, the selling status display apparatus 100 may be configured to generate a first graph representing the rate of the number of sales corresponding to the number of items received at respective stores with regard to a designated item. Thus, with regard to the designated item, even when the number of items received is different among the respective stores, it is possible to generate a graph with which variation in sales among these stores may be determined.

(2) The selling status display apparatus 100 refers to a storage unit 110 to specify an item category to which a designated item belongs. In this case, the storage unit 110 stores therein information indicating a corresponding relation between the item category and an item belonging to the item category. The item category is a classification for classifying items.

As “clothes” sold at a clothes store are exemplified, item categories include “topwear”, “bottomwear”, and “dress”, for example. Further, items belonging to the item category “topwear” include “jacket”, “cardigan”, and “shirt”, for example. In this case, for example, when the item “shirt” is designated, the selling status display apparatus 100 refers to the storage unit 110 to specify the item category “topwear” to which the item “shirt” belongs.

As “drinks” sold at a supermarket are exemplified, item categories include “vegetables”, “liquors”, and “sweets”, for example. Further, items belonging to the item category “liquors” include “beer”, “sake”, “distilled spirits”, and “wine”, for example. In this case, for example, when the item “wine” is designated, the selling status display apparatus 100 refers to the storage unit 110 to specify the item category “liquors” to which the item “wine” belongs.

(3) The selling status display apparatus 100 generates a second graph representing the selling status at each store and variation in sales among stores with regard to a specified item category.

In particular, for example, the selling status display apparatus 100 may be configured to generate a second graph representing the number of sales at respective stores with regard to a specified item category. The number of sales at the respective stores with regard to the item category is a total of the numbers of sales of all items belonging to the item category in question. Thus, with regard to the specified item category, it is possible to generate a graph with which the selling status at each store may be determined based on the number of sales at the respective stores.

Furthermore, for example, the selling status display apparatus 100 may be configured to generate a second graph representing the rate of the number of sales corresponding to the number of items received at respective stores with regard to a specified category. The number of items received at the respective stores with regard to the item category is a total of the numbers of all items received belonging to the specified item category. Thus, with regard to the specified item category, even when the number of items received is different among the respective stores, it is possible to generate a graph with which variation in sales among these stores may be determined.

(4) The selling status display apparatus 100 displays the generated second graph simultaneously with the generated first graph. In particular, for example, the selling status display apparatus 100 may be configured to display the first graph and the second graph side by side on the same screen, or to display the first graph and the second graph simultaneously in the same coordinate system.

In the example of FIG. 1, as a result of the item “wine”, which is sold at multiples stores including a store A, a store B, a store C, and a store D, being designated, a first graph G1 and a second graph G2 are simultaneously displayed on a display 120. The display 120 may be included in the selling status display apparatus 100, or may be included in another device that is connected to the selling status display apparatus 100.

In this example, the first graph G1 is a line graph representing the number of sales at the respective stores, which are the stores A to D, with regard to the designated item “wine”. The second graph G2 is a line graph representing the numbers of sales at the respective stores, which are the stores A to D, with regard to all items belonging to the item category “liquors”, to which the item “wine” belongs.

In this manner, according to the selling status display apparatus 100, when the first graph related to a designated item is displayed, by specifying the item category to which the designated item belongs, it is possible to display the second graph related to the item category in question with the first graph. Thus, it is possible to facilitate ascertaining the selling status of each item at the respective stores.

For example, according to the first graph G1, with regard to the designated item “wine”, it is understood that the number of sales at the store B is significantly larger than those at other stores, and there is a large variation in the selling status of the specified item among these stores. Therefore, with regard to the item “wine”, it is possible to determine that, for example, the sale of stock may be facilitated by conducting inter-store transfer from the store A, the store B, and the store D having a smaller number of sales of the item to the store B having a larger number of sales thereof.

Meanwhile, according to the second graph G2, with regard to the item category “liquors” to which the designated item “wine” belongs, it is understood that although the number of sales at the store B is slightly larger than those at other stores, there is little variation in sales among these stores. Therefore, with regard the item category “liquors”, as for items other than the item “wine”, even without checking the number of items received, the number of sales, and the number of items in stock at respective stores, it is possible to determine that there is no large variation in sales among these stores and that the necessity of conducting operations such as inter-store transfer is less.

Thus, according to the selling status display apparatus 100, with regard to a certain item, when the selling status thereof at each store is checked, it is possible to determine whether there is any variation in sales among stores for other items in the item category to which the certain item belongs. Therefore, at companies such as those operating multiple stores, it is possible to reduce the time and labor when the selling status of each item at respective stores is ascertained and to support planning processes of operations such as inter-store transfer and changing selling prices.

Next, as an example, a case will be described where the selling status display apparatus 100 depicted in FIG. 1 is applied to a business support system 200, which is introduced to a company that operates multiple stores selling clothes.

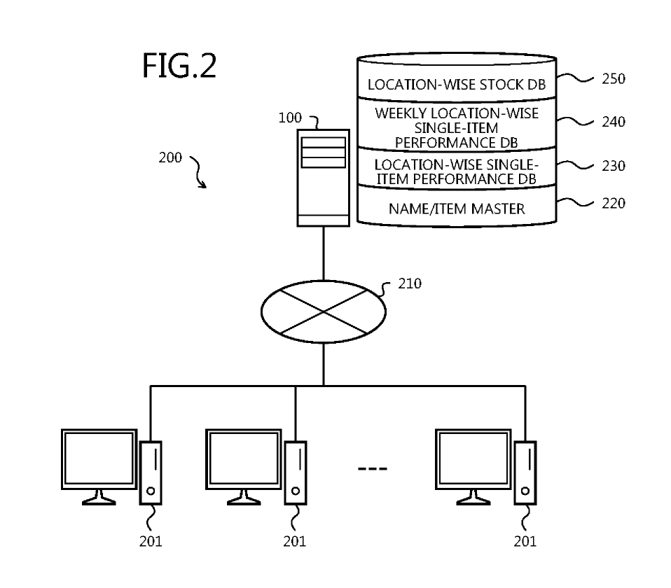

FIG. 2 is an explanatory diagram depicting a system configuration example of the business support system 200. In FIG. 2, the business support system 200 includes the selling status display apparatus 100 and client apparatuses 201. In the business support system 200, the selling status display apparatus 100 and the client apparatuses 201 are connected to each other via a wired or wireless network 210. The network 210 is, for example, a LAN (Local Area Network), a WAN (Wide Area Network), or the Internet.

In this example, the selling status display apparatus 100 includes a name/item master 220, a location-wise single-item performance database (DB) 230, a weekly location-wise single-item performance DB 240, and a location-wise stock DB 250, and supports ascertaining the selling status of each item at the respective stores. The selling status display apparatus 100 is a server, for example.

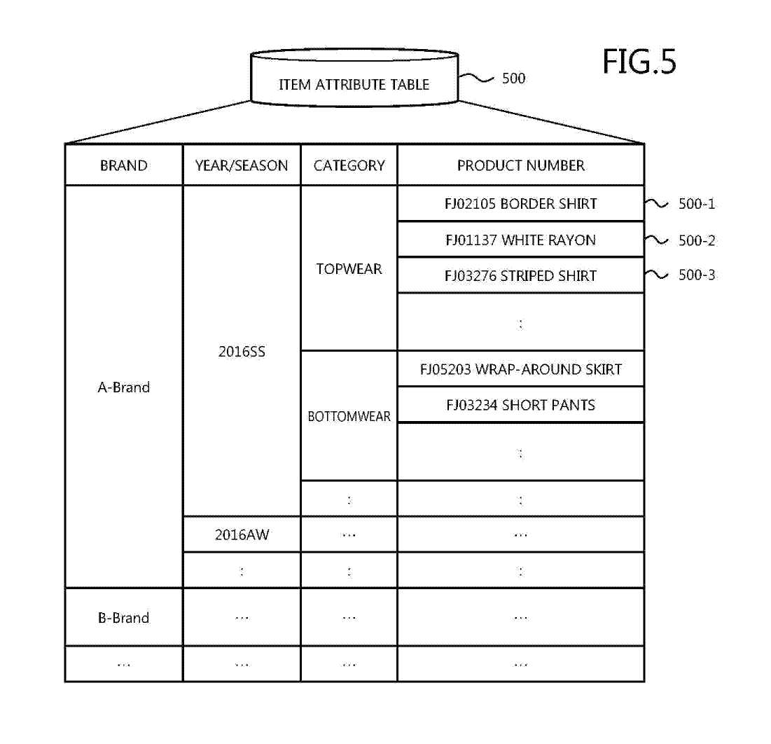

The name/item master 220 stores therein information related to stores and information related to items to be sold at the stores. The items include clothes, underwear, shoes, and bags, for example. For example, each of the items is managed with a product number uniquely identifying each of the items. The name/item master 220 includes, for example, an item attribute table 500 depicted in FIG. 5 and a store consumption rate table 600 described later.

The location-wise single-item performance DB 230 stores therein, with regard to each item identified by a product number, a cumulative number of items received and a cumulative number of sales at respective stores. The cumulative number of items received is a cumulative quantity of items in stock (arrived) at a store. The cumulative number of items received includes, for example, the quantity of items transferred from another store by inter-store transfer. The cumulative number of sales is a cumulative quantity of items sold at a store.

The weekly location-wise single-item performance DB 240 stores therein, with regard to each item identified by a product number, weekly location-wise single-item performance information indicating the weekly due stock quantity, the quantity of items received, the amount of net sales, and the quantity of store-stock transition at respective stores. The due stock quantity is the quantity of items due to arrive at a store in the corresponding week. The quantity of items received is the quantity of items arrived at a store in the corresponding week. The amount of net sales is the quantity of items sold at a store in the corresponding week. The quantity of store-stock transition is the number of items in stock at a store in the corresponding week.

The selling status display apparatus 100 may be also configured to store therein the due stock quantity, the quantity of items received, the amount of net sales, and the quantity of store-stock transition at respective stores on a daily or hourly basis, for example.

The location-wise stock DB 250 stores therein the present number of items in stock at the respective stores with regard to each item identified by a product number. Further, the location-wise stock DB 250 may store therein the total number of items in stock at respective stores with regard to each item category for classifying items. The total number of items in stock is a total of the present number of each item in stock belonging to a certain item category.

For example, the data stored in the DBs 220, 230, 240, and 250 and the like may be registered manually, or may be registered by other systems that manage the number of items received, the number of sales, and the number of items in stock of each item at each store.

The client apparatus 201 is a computer such as a PC (personal computer), a tablet terminal, or a smartphone. For example, the client apparatus 201 is used by a user who analyses the selling status of items at respective stores and plans operations such as inter-store transfer and changing selling prices.

In the business support system 200, for example, upon reception of a request for displaying various screens from the client apparatus 201, the selling status display apparatus 100 generates screen information of various screens and transmits the generated information to the client apparatus 201. Thus, the client apparatus 201 can display the various screens.

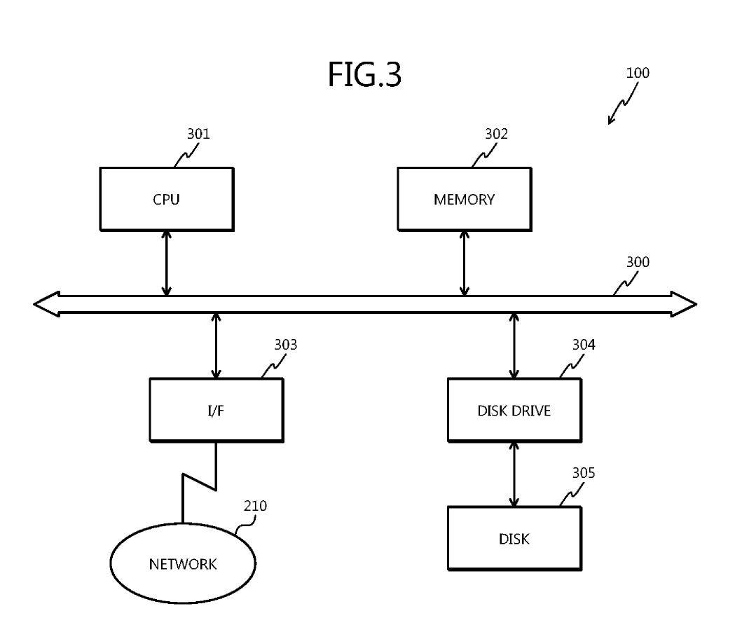

FIG. 3 is a block diagram of hardware configuration of the selling status display apparatus 100. In FIG. 3, the selling status display apparatus 100 has a central processing unit (CPU 301), the memory 302, an interface (I/F) 303, the disk drive 304, and the disk 305, respectively connected by a bus 300.

Here, the CPU 301 governs overall control of the selling status display apparatus 100. The memory 302, for example, includes a read-only memory (ROM), a random access memory (RAM), and a flash ROM. In particular, for example, the flash ROM and the ROM store therein various types of programs, and the RAM is used as a work area of the CPU 301. A program stored in the memory 302 is loaded onto the CPU 301, whereby a coded process is executed by the CPU 301.

The I/F 303 is connected to the network 210 through a communications line and is connected to other apparatuses (e.g., the client apparatuses 201 depicted in FIG. 2) via the network 210. The I/F 303 administers an internal interface with the network 210, and controls the input and output of data from other apparatuses. The I/F 303, for example, may be a modem, a LAN adapter, etc.

The disk drive 304, under the control of the CPU 301, controls the reading and writing of information with respect to the disk 305. The disk 305 stores data written thereto under the control of the disk drive 304. The disk 305, for example, may be a magnetic disk, an optical disk, etc.

The various DBs 220, 230, 240, and 250 depicted in FIG. 2, for example, are realized by a storage apparatus such as the memory 302, the disk 305, etc. Further, in addition to the configuration above, the selling status display apparatus 100 may include, for example, a solid state drive, a keyboard, a mouse, a display, etc.

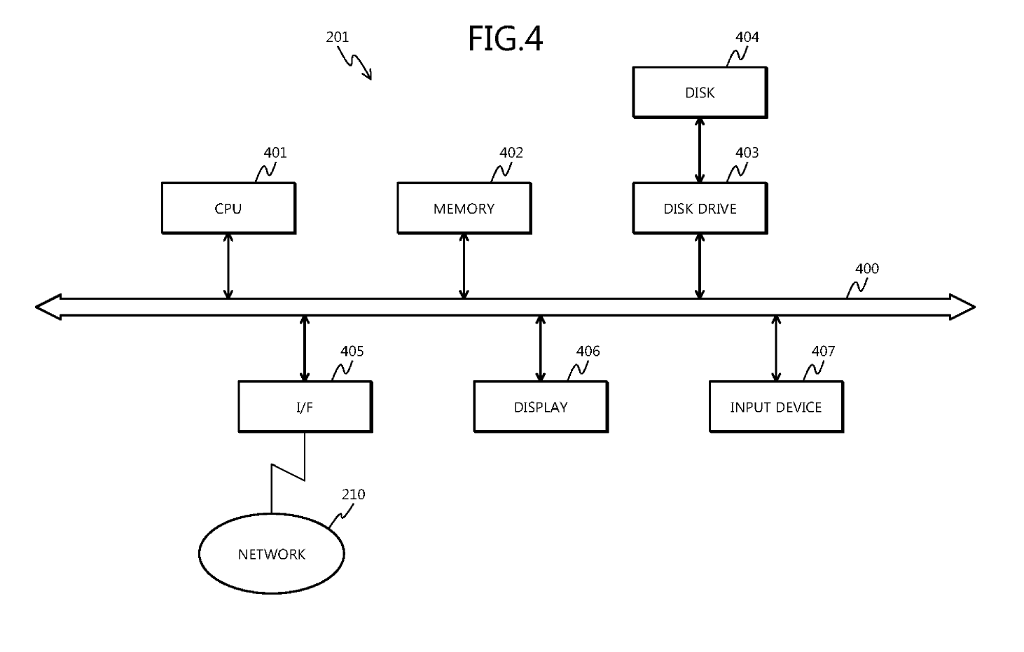

FIG. 4 is a block diagram of hardware configuration of a client apparatus 201. In FIG. 4, the client apparatus 201 has a CPU 401, a memory 402, a disk drive 403, a disk 404, an I/F 405, a display 406, and an input device 407, respectively connected by a bus 400.

Here, the CPU 401 governs overall control of the client apparatus 201. The memory 402, for example, includes a ROM, a RAM, and a flash ROM. In particular, for example, the flash ROM and the ROM store therein various types of programs, and the RAM is used as a work area of the CPU 401. A program stored in the memory 402 is loaded on the CPU 401, whereby a coded program is executed by the CPU 401.

The disk drive 403, under the control of the CPU 401, controls the reading and writing of data with respect to the disk 404. The disk 404 stores data written thereto under the control of the disk drive 403. The disk 404 is, for example, a magnetic disk, an optical disk, etc.

The I/F 405 is connected to the network 210 through a communications line and is connected to other apparatuses (e.g., the selling status display apparatus 100 depicted in FIG. 2) via the network 210. The I/F 405 administers an internal interface with the network 210, and controls the input and output of data from other apparatuses.

The display 406 displays data such as documents, images, and functional information, in addition to a cursor, icons, and toolboxes. The display 406, for example, may be a liquid crystal display, a cathode ray tube (CRT), etc.

The input device 407 has keys for inputting characters, numerals, various instructions, etc. and performs data input. The input device 407 may be a keyboard or a mouse, or a touch panel input pad or a numeric pad. The client apparatus 201, for example, may omit the disk drive 403, the disk 404.

Next, the storage contents of the item attribute table 500 included in the selling status display apparatus 100 are described. As described above, the item attribute table 500 is included, for example, in the name/item master 220 depicted in FIG. 2. The storage unit 110 depicted in FIG. 1 corresponds to, for example, the item attribute table 500.

FIG. 5 is an explanatory diagram depicting an example of storage contents of the item attribute table 500. In FIG. 5, the item attribute table 500 includes fields of brand, year/season, category, and product number. By setting information in each field, item attribute information (for example, item attribute information 500-1 to 500-3) is stored as a record.

In this example, the brand is a name of the brand of an item. The year/season is a season name indicating which year and which season a certain item is targeted for. Examples of the year/season include 2016SS (Spring/Summer) and 2016AW (Autumn/Winter).

The category is a classification classifying items. The types of the category include, for example, “topwear”, “bottomwear”, “dress”, and “shoes”. Each of the brand, year/season, and category is an item attribute characterizing items that are respectively identified by a product number. The product number is an identifier uniquely identifying the items. In the example of FIG. 5, in the product number field, the product number (for example, FJ02105) and the name (for example, border shirt) of an item are set.

Next, storage contents of the store consumption rate table 600 included in the selling status display apparatus 100 are described. As described above, the store consumption rate table 600 is included, for example, in the name/item master 220 depicted in FIG. 2.

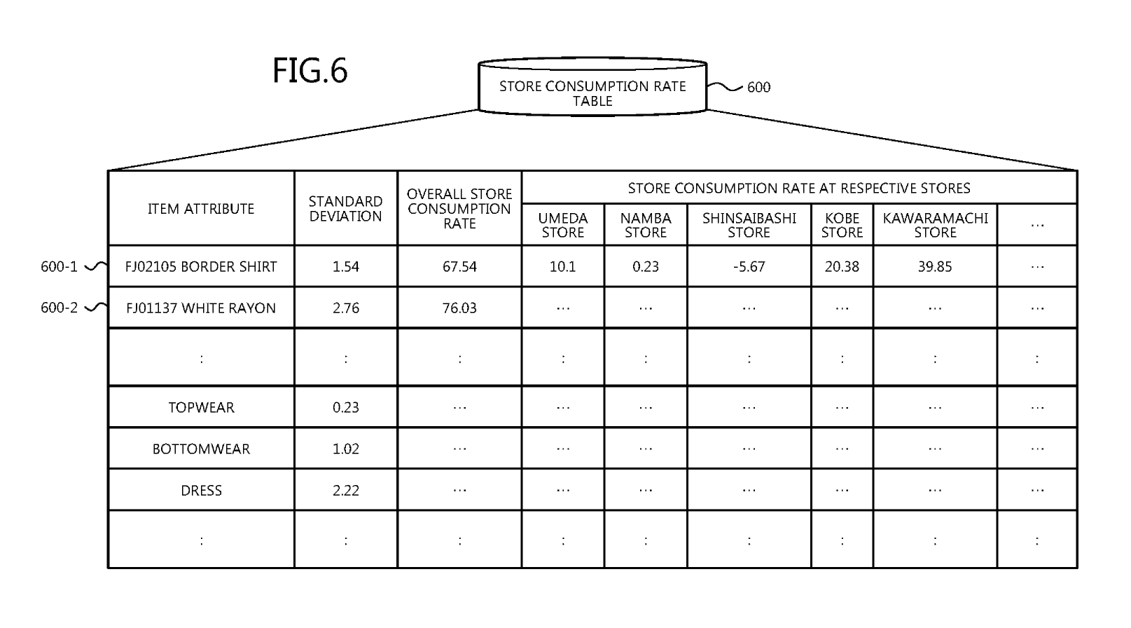

FIG. 6 is an explanatory diagram depicting an example of storage contents of the store consumption rate table 600. In FIG. 6, the store consumption rate table 600 includes fields of item attribute, standard deviation, overall store consumption rate, and store consumption rate at respective stores. By setting information in each field, store consumption rate information (for example, store consumption rate information 600-1, 600-2) is stored as a record.

In this example, the item attribute is an attribute characterizing items. In the item attribute field, for example, item attributes such as a brand, a year/season, a category, and a product number are set. The standard deviation is a standard deviation of the store consumption rate of an item specified from the item attribute at respective stores. For example, an item specified from an item attribute “FJ02105 border shirt” is an item of a product number “FJ02105 border shirt”. Further, items specified from an item attribute “topwear” are all items belonging to a category “topwear”. The all items belonging to the category “topwear” are, for example, specified from the item attribute table 500 depicted in FIG. 5.

The store consumption rate at respective stores represents a rate of a cumulative quantity of sales with respect to a cumulative quantity of items received at the respective stores, with regard to items specified from item attributes. The store consumption rate may be acquired by using equation (1), for example. The cumulative quantity of sales and the cumulative quantity of items received may be specified from the location-wise single-item performance DB 230 depicted in FIG. 2.

Store consumption rate at respective stores=cumulative quantity of sales at respective stores/cumulative quantity of items received at respective stores×100 (1)

The store consumption rate at respective stores becomes an index for determining the selling status at each store with regard to items specified from item attributes. The standard deviation of the store consumption rate at the respective stores may be acquired by obtaining the variance of the store consumption rate at the respective stores and taking the positive square root. The standard deviation of the store consumption rate at the respective stores becomes an index for determining variation in sales among stores with regard to items specified from the item attributes.

The overall store consumption rate represents a rate of a cumulative quantity of sales with respect to the cumulative quantity of items received at all stores with regard to items specified from item attributes. The overall store consumption rate becomes an index for determining the comprehensive selling status at all the stores with regard to the items specified from the item attributes.

The deviation of the store consumption rate at the respective stores represents a deviation from a standard value of store consumption rate, and the deviation may be acquired by using equation (2), for example. The average store consumption rate is an average value of store consumption rates at respective stores.

Deviation of store consumption rate at respective stores=store consumption rate at respective stores−average store consumption rate (2)

For example, at stores where the deviation of the store consumption rate is larger than “0”, it is determined that, with regard to items specified from item attributes, these items are consumed (sold) more than the average of all stores. On the other hand, at stores where the deviation of the store consumption rate is smaller than “0”, it is determined that, with regard to items specified from item attributes, these items are not consumed (sold) more than the average of all the stores.

Configuration may be such that various numerals (standard deviation, overall store consumption rate, and deviation of store consumption rate at respective stores) in the store consumption rate table 600 are calculated by, for example, the selling status display apparatus 100, and further, configuration may be such that the selling status display apparatus 100 acquires numerals calculated by another computer.

Next, a screen example of an item-attribute selection screen 700 displayed on the display 406 of the client apparatus 201 is described. In the following descriptions, as an operation in which a user selects a box, a button, and the like displayed on various screens of the client apparatus 201, a case where a click operation using the input device 407 depicted in FIG. 4 is performed will be described as an example.

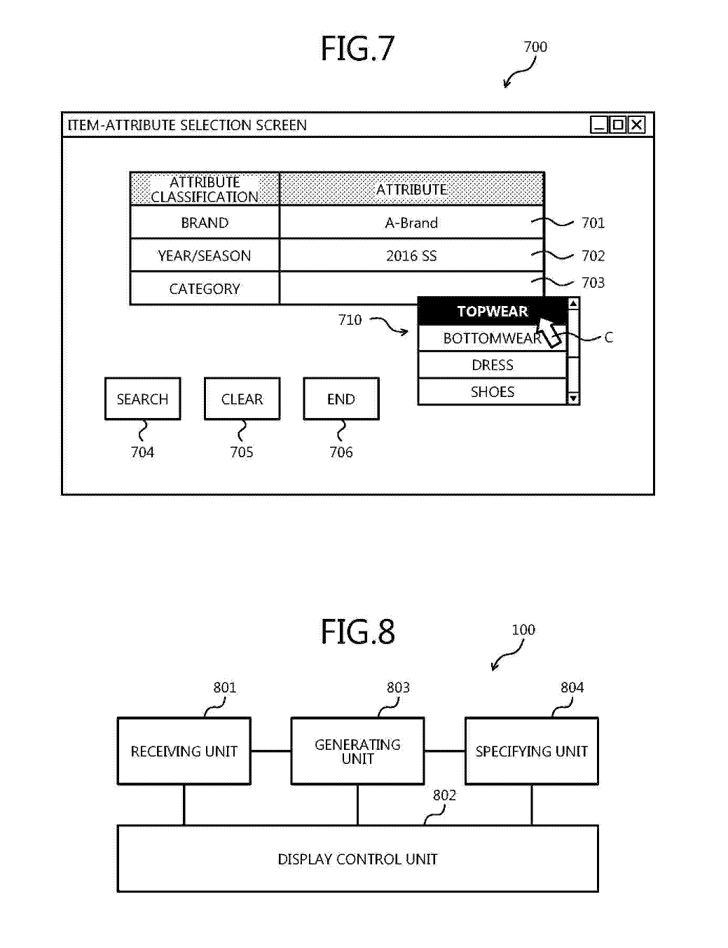

FIG. 7 is an explanatory diagram depicting a screen example of the item-attribute selection screen 700. In FIG. 7, the item-attribute selection screen 700 is an operation screen for selecting the item attribute of an item that is to be subject to analysis concerning the selling status. On the item-attribute selection screen 700, when a cursor C is moved to click a box 701, the brand of the item may be selected. By clicking a box 702, the year/season of the item may be selected. By clicking a box 703, the category of the item may be selected.

To be more specific, for example, when the box 703 is clicked, a category list 710 in which selectable categories are listed is displayed, and any one of the categories may be selected from the category list 710. The selectable categories are, for example, categories registered in the item attribute table 500.

On the item-attribute selection screen 700, when a search button 704 is clicked, a selection result of the item attribute is transmitted from the client apparatus 201 to the selling status display apparatus 100. For example, when the search button 704 is clicked in a state where a brand “A-Brand”, a year/season “2016SS”, and a category “topwear” are selected, a selection result “A-Brand, 2016SS, topwear” of the item attribute is transmitted.

Furthermore, on the item-attribute selection screen 700, when a clear button 705 is clicked, the item attributes selected in the boxes 701 to 703 may be cleared. On the item-attribute selection screen 700, when an end button 706 is clicked, the display of the item-attribute selection screen 700 may be ended.

Next, a functional configuration example of the selling status display apparatus 100 is described.

FIG. 8 is a block diagram depicting a functional configuration example of the selling status display apparatus 100. In FIG. 8, the selling status display apparatus 100 includes a receiving unit 801, a display control unit 802, a generating unit 803, and a specifying unit 804. The receiving unit 801, the display control unit 802, the generating unit 803, and the specifying unit 804 are functions forming a control unit. In particular, for example, the functions are realized by causing the CPU 301 to execute a program stored in a storage apparatus such as the memory 302 or the disk 305 depicted in FIG. 3, or realized by the I/F 303. Processing results of the functional units are stored to a storage apparatus such as the memory 302 or the disk 305.

The receiving unit 801 receives selection of the item attribute of an item to be subject to analysis concerning the selling status. The selection of the item attribute is, for example, performed on the item-attribute selection screen (see FIG. 7) displayed on the display 406 of the client apparatus 201. In particular, for example, by a reception of a selection result of the item attribute from the client apparatus 201, the receiving unit 801 receives the selection of the item attribute.

The display control unit 802 executes control of displaying an item specified from a selected item attribute. Here, for example, the display control unit 802 may be configured to display a value indicating a degree of variation in selling statuses among stores with regard to the item specified from the selected item attribute. The value indicating the degree of variation in the selling statues among stores is, for example, a standard deviation of the store consumption rate at the respective stores.

Furthermore, for example, the display control unit 802 may be configured to display information so as to enable designation of a predetermined item for which a value indicating the degree of variation in the selling statuses among stores is larger than a predetermined value. The predetermined value may be arbitrarily set. Thus, it is possible to display items having a certain degree of variation in the selling statuses among stores while the items are listed.

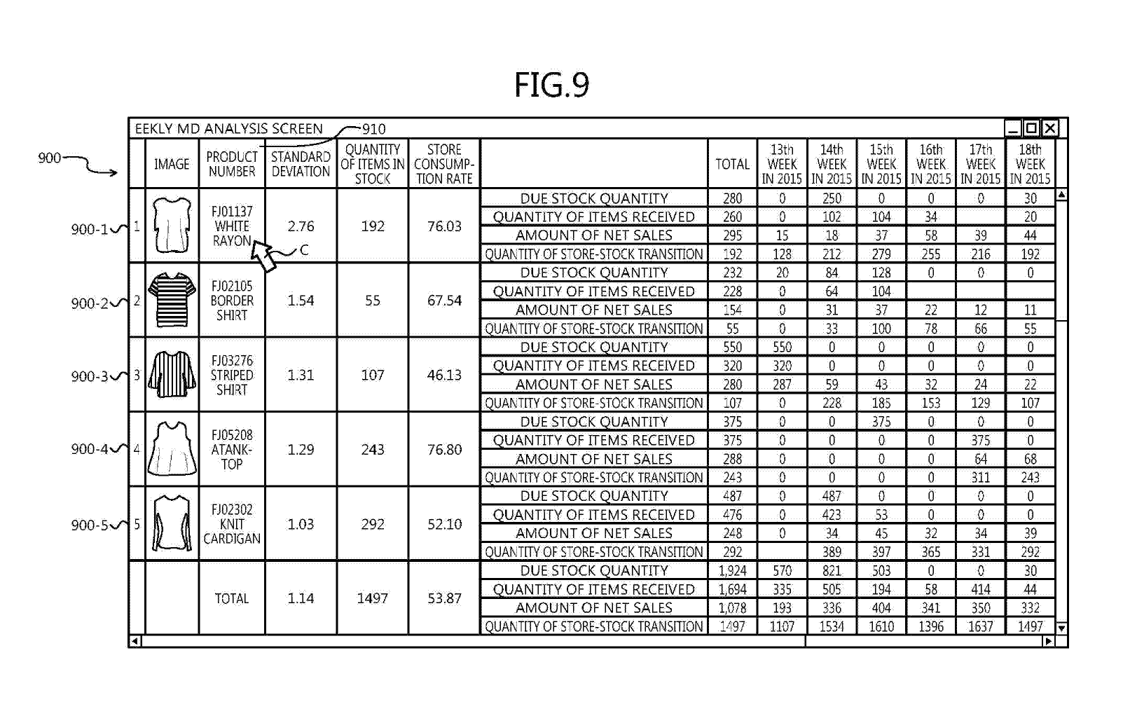

In particular, for example, first, the display control unit 802 refers to the item attribute table 500 depicted in FIG. 5 to specify an item corresponding to a selected item attribute. Next, with regard to the specified item, the display control unit 802 refers to, for example, the weekly location-wise single-item performance DB 240, the location-wise stock DB 250, and the store consumption rate table 600, and generates screen information of a weekly MD analysis screen 900 depicted in FIG. 9 described later.

Subsequently, the display control unit 802 transmits the generated screen information of the weekly MD analysis screen 900 to the client apparatus 201. Thus, the weekly MD analysis screen 900 may be displayed on the display 406 of the client apparatus 201. The weekly MD analysis screen 900 is an operation screen for displaying information such that items for which the standard deviation of the store consumption rate at the respective stores is larger than a predetermined value (for example, 1) may be listed and designated.

The receiving unit 801 receives designation of an item to be subject to analysis concerning the selling status. The designation of the item is, for example, performed on the weekly MD analysis screen 900 (see FIG. 9 described later) that is displayed on the display 406 of the client apparatus 201. In particular, for example, by reception of a designation result of the item from the client apparatus 201, the receiving unit 801 receives the designation of the item.

The generating unit 803 generates a first graph representing the selling status at each store or variation in sales among stores with regard to a designated item. In particular, for example, with regard to the designated item, the generating unit 803 may be configured to generate a first graph based on the deviation of the store consumption rate indicating a ratio of the number of sales (the cumulative quantity of sales) to the number of items received (the cumulative quantity of items received) at each of the stores.

To be more specific, first, the generating unit 803 refers to the store consumption rate table 600, for example, to specify the deviation of the store consumption rate at the respective stores with regard to the designated item. Next, for each predetermined deviation range, the generating unit 803 calculates the number of stores corresponding to the deviation range. For example, when a predetermined deviation range is set as “−5≦deviation<5”, the generating unit 803 calculates the number of stores for which the deviation of the specified store consumption rate is “−5≦deviation<5”. The predetermined deviation range may be arbitrarily set.

Next, the generating unit 803 calculates a first store count rate for each of predetermined deviation ranges. The first store count rate indicates a rate of the number of stores corresponding to a predetermined deviation range to the number of all stores having sold a designated item, and the first store count rate may be acquired by using equation (3), for example. The number of all stores having sold the designated item is, for example, specified from the store consumption rate table 600.

First store count rate=number of stores corresponding to predetermined deviation range/number of all stores having sold designated item×100 (3)

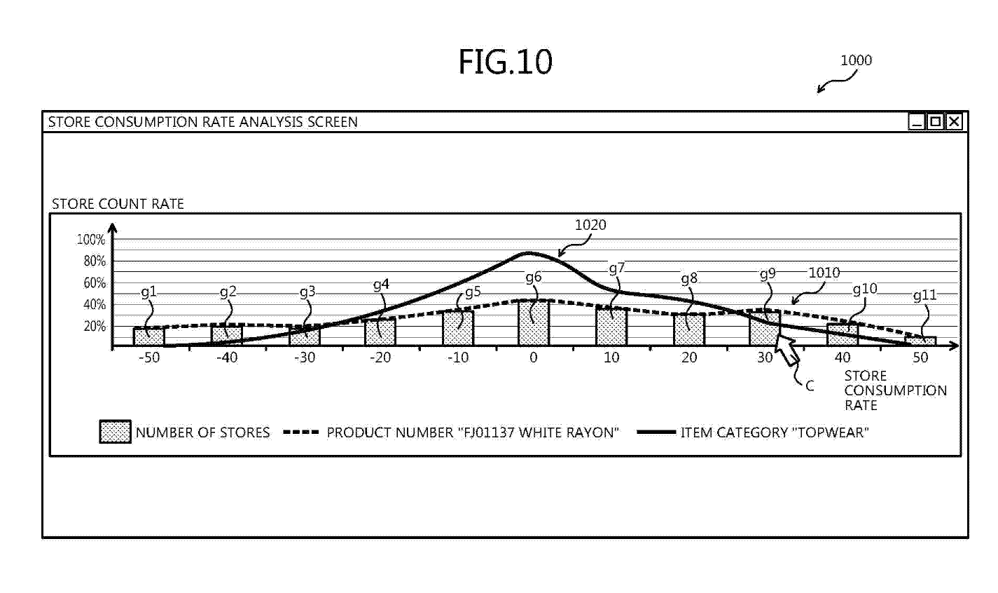

The first store count rate becomes an index for determining the rate of the number of stores corresponding to a predetermined deviation range among the number of all stores having sold a designated item. For each of predetermined deviation ranges, the generating unit 803 generates a first graph representing the first store count rate corresponding to the predetermined deviation range. The types of the first graph include a bar graph, a line graph, and a circle graph. A specific example of the first graph is described later with reference to FIG. 10.

The specifying unit 804 specifies an item category to which a designated item belongs. In particular, for example, the specifying unit 804 refers to the item attribute table 500 depicted in FIG. 5 to specify the item category to which the designated item belongs. In this example, a case is assumed where an item of a product number “FJ01137 white rayon” is designated.

In this case, the specifying unit 804 refers to the item attribute table 500 to specify the category “topwear” to which the item of the product number “FJ01137 white rayon” belongs. Here, the specifying unit 804 may specify a year/season “2016SS” to which the category “topwear” belongs or a brand “A-Brand” to which the year/season “2016SS” belongs, as an item category to which the item of the product number “FJ01137 white rayon” belongs.

Furthermore, the generating unit 803 generates a second graph representing the selling status at each store or variation in sales among stores with regard to a specified item category. In particular, for example, with regard to the specified item category, the generating unit 803 may generate the second graph based on a deviation of store consumption rates indicating the ratio of the number of sales (the cumulative quantity of sales) to the number of items received (the cumulative quantity of items received) at each of the stores.

To be more specific, the generating unit 803 first refers to the store consumption rate table 600, for example, to specify a deviation of the store consumption rates at respective stores with regard to a specified item category. Next, with regard to each of predetermined deviation ranges, the generating unit 803 calculates the number of stores corresponding to the deviation range. The predetermined deviation ranges may be arbitrarily set, and are set as the same ranges as those of the first graph.

Next, the generating unit 803 calculates a second store count rate for each of the predetermined deviation ranges. The second store count rate is a rate of the number of stores corresponding to a predetermined deviation range with regard to the number of all stores having sold an item belonging to a specified item category. The second store count rate may be acquired by using equation (4), for example. The number of all stores having sold the item belonging to the specified item category is, for example, specified from the store consumption rate table 600.

Second store count rate=number of stores corresponding to predetermined deviation range/number of all stores having sold item belonging to specified item category×100 (4)

The second store count rate becomes an index for determining the rate of the number of stores corresponding to a predetermined deviation range among the number of all stores having sold an item belonging to a specified item category. For each of predetermined deviation ratio, the generating unit 803 generates a second graph representing the second store count rate corresponding to the predetermined deviation range. The types of the second graph include a bar graph, a line graph, and a circle graph. A specific example of the second graph is described later with reference to FIG. 10.

The display control unit 802 executes control of displaying the generated second graph simultaneously with the generated first graph. In particular, for example, based on the generated first and second graphs, the display control unit 802 generates screen information of a store consumption rate analysis screen 1000 depicted in FIG. 10 described later. The display control unit 802 then transmits the screen information of the generated store consumption rate analysis screen 1000 to the client apparatus 201. Thus, the store consumption rate analysis screen 1000 may be displayed on the display 406 of the client apparatus 201.

Furthermore, the receiving unit 801 may receive designation of any of deviation range among predetermined deviation ranges, as a result of the first graph and the second graph being displayed simultaneously. The designation of the deviation range is, for example, performed on the store consumption rate analysis screen 1000 (see FIG. 10 described later) displayed on the display 406 of the client apparatus 201. In particular, for example, by a reception of a designation result of the deviation range from the client apparatus 201, the receiving unit 801 receives the designation of the deviation range.

The generating unit 803 generates, with regard to a designated item, a third graph representing at least one of the number of sales and the number of items in stock at respective stores corresponding to a designated deviation range. In particular, for example, the generating unit 803 first refers to the store consumption rate table 600 to specify stores corresponding to a designated deviation range. For example, when the designated deviation range is “25≦deviation<35”, the generating unit 803 specifies stores for which the deviation of the store consumption rate is “25≦deviation<35” with regard to the designated item.

Next, for example, the generating unit 803 refers to the location-wise single-item result DB 230 depicted in FIG. 2 to specify the cumulative number of sales at a specified store with regard to the designated item. Further, the generating unit 803 refers to, for example, the location-wise stock DB 250 depicted in FIG. 2 to specify the current number of items in stock at the specified store with regard to the designated item.

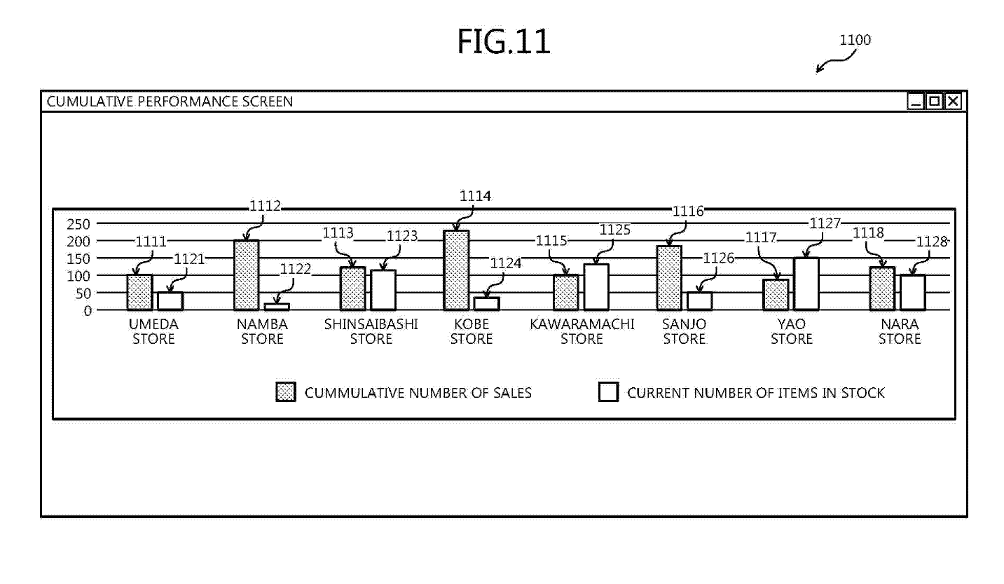

Subsequently, the generating unit 803 generates a third graph representing the cumulative number of sales and the present number of items in stock at each of the specified stores with regard to the designated item. The types of the third graph include a bar graph, a line graph, and a circle graph. A specific example of the third graph is described later with reference to FIG. 11.

The display control unit 802 executes control of displaying the generated third graph. In particular, for example, the display control unit 802 generates based on the generated third graph, screen information of a cumulative performance screen 1100 depicted in FIG. 11 described later. The display control unit 802 then transmits the screen information of the generated cumulative performance screen 1100 to the client apparatus 201. Thus, the cumulative performance screen 1100 may be displayed on the display 406 of the client apparatus 201.

Next, a screen example of the weekly MD analysis screen 900 displayed on the display 406 of the client apparatus 201 is described.

FIG. 9 is an explanatory diagram depicting a screen example of the weekly MD analysis screen 900. In FIG. 9, the weekly MD analysis screen 900 is an operation screen displaying information such that items for which the standard deviation of the store consumption rate at respective stores is larger than “1” may be listed and designated. On the weekly MD analysis screen 900, weekly MD analysis information 900-1 to 900-5 is displayed.

Each of the weekly MD analysis information 900-1 to 900-5 represents an image and a product number of each item, the standard deviation of the store consumption rate at the respective stores, the quantity of items in stock at all stores, and the store consumption rate at all the stores. Further, each of the weekly MD analysis information 900-1 to 900-5 represents the quantity of weekly due stock, the quantity of items received, the amount of net sales, and the quantity of store-stock transition.

According to the weekly MD analysis screen 900, a user can designate an item to be to be subject to analysis concerning the selling status among items having a certain degree of variation in the selling statuses among stores. Further, for example, by referring to the standard deviation of store consumption rates at the respective stores, the user may designate the item to be subject to analysis concerning the selling status with consideration of the degree of variation in the selling statuses among stores.

Furthermore, by referring to the quantity of items in stock at all stores, the user may designate an item to be to be subject to analysis concerning the selling statuses with consideration of the present number of items in stock at all the stores. Further, by referring to the store consumption rate at all the stores, for example, the user can designate an item to be subject to analysis concerning the selling status in consideration of the comprehensive sales at all the stores.

Furthermore, by referring to the quantity of weekly due stock, the quantity of items received, the amount of net sales, and the quantity of store-stock transition, for example, the user can designate an item to be subject to analysis concerning the selling status with consideration of the weekly selling status of each item at all the stores. The period (in the example of FIG. 9, 13th week in 2015 to 18th week in 2015) for which the quantity of weekly due stock, the quantity of items received, the amount of net sales, and the quantity of store-stock transition is displayed may be changed arbitrarily.

Further, on the weekly MD analysis screen 900, when the cursor C is moved to click a product number in a product number column 910, the item of the clicked product number may be designated as an item to be subject to analysis concerning the selling status. For example, when the product number “FJ01137 white rayon” is clicked, the item of the product number “FJ01137 white rayon” is designated, and the screen shifts to the store consumption rate analysis screen 1000 depicted in FIG. 10.

Next, the store consumption rate analysis screen 1000 displayed on the display 406 of the client apparatus 201 is described.

FIG. 10 is an explanatory diagram depicting a screen example of the store consumption rate analysis screen 1000. In FIG. 10, the store consumption rate analysis screen 1000 is an operation screen for displaying a first graph 1010 and a second graph 1020 simultaneously, in a coordinate system constituted by an axis (the horizontal axis) representing a deviation of a store consumption rate and an axis (the vertical axis) representing a store number ratio.

The first graph 1010 is a curve graph representing, with regard to each predetermined deviation range, the first store count rate corresponding to the predetermined deviation range. The first store count rate is an index for determining the rate of the number of stores corresponding to a predetermined deviation range among all stores having sold a designated item.

According to the first graph 1010, with regard to the product number “FJ01137 white rayon”, variation in sales among stores may be determined. In particular, for example, according to the first graph 1010, even though the first store count rate is largest around a deviation “0”, it cannot be said that the first store count rate is biased around the deviation “0” and thus, it is determined that the selling variation among the stores is large. Therefore, the user can determine that, with regard to the item of the product number “FJ01137 white rayon”, it is necessary to perform operations such as inter-store transfer and changing selling prices.

The second graph 1020 is a curve graph representing, with regard to each predetermined deviation range, the second store count rate corresponding to the predetermined deviation range. As described above, the second store count rate is an index for determining the rate of the number of stores corresponding to a predetermined deviation range among all stores having sold an item belonging to a specified item category.

According to the second graph 1020, with regard to the item category “topwear”, variation in sales among stores may be determined. In particular, for example, according to the second graph 1020, because the second store count rate around the deviation “0” is largest and the second store count rate is biased around the deviation “0”, it is determined that the variation in sales among these stores is small. Therefore, the user can determine that, with regard to other items belonging to the item category “topwear”, there is no large variation in the selling statuses among these stores as compared to that of the item of the product number “FJ01137 white rayon”, and that there is less necessity of performing operations such as inter-store transfer.

As described above, according to the store consumption rate analysis screen 1000, with regard to the item of the product number “FJ01137 white rayon”, when variation in sales among stores is checked, it is possible to determine variation in sales among the stores for other items of the item category “topwear” to which the concerned item belongs.

On the store consumption rate analysis screen 1000, when the cursor C is moved to click any of bar graphs g1 to g11, it is possible to designate a deviation range corresponding to the concerned bar graph. For example, when the bar graph g9 is clicked, a deviation range “25≦deviation<35” corresponding to the bar graph 9g is designated, and the screen shifts to the cumulative performance screen 1100 depicted in FIG. 11.

Next, a screen example of the cumulative performance screen 1100 displayed on the display 406 of the client apparatus 201 is described.

FIG. 11 is an explanatory diagram depicting a screen example of the cumulative performance screen 1100. In FIG. 11, the cumulative performance screen 1100 is a screen displayed on the store consumption rate analysis screen 1000 depicted in FIG. 10 when the bar graph g9 is clicked. Bar graphs 1111 to 1118 and bar graphs 1121 to 1128 corresponding to the third graph described above are displayed on the cumulative performance screen 1100.

Each of the bar graphs 1111 to 1118 represents, with regard to the items of the product number “FJ01137 white rayon”, the cumulative number of sales at stores having a deviation range “25≦deviation<35” as the deviation of the store consumption rate. The stores having the deviation range “25≦deviation<35” as the deviation of the store consumption rate are stores where the items of the product number “FJ01137 white rayon” are consumed (sold) more than the average of all stores.

Each of the bar graphs 1121 to 1128 represents, with regard to the items of the product number “FJ01137 white rayon”, the current number of items in stock at stores having the deviation ratio “25≦deviation<35” as the deviation of the store consumption rate. The deviation range “25≦deviation<35” is a deviation range corresponding to the bar graph g9 depicted in FIG. 10.

According to the cumulative screen 1100, for example, a user can determine that the items of the product number “FJ01137 white rayon” are consumed more than the average of all stores at the Namba store, the Kobe store, and the Sanjo store, and the current number of items in stock are less at these stores. Therefore, the user can determine that the Namba store, the Kobe store, and the Sanjo store should receive the items, by inter-store transfer or the like from other stores where the items are not consumed more than the average of all stores.

As for the items of the product number “FJ01137 white rayon”, the cumulative number of sales and the current number of items in stock at the stores where the items are not consumed more than the average of all stores may be checked by, for example, clicking the bar graphs g1 to g5 on the store consumption rate analysis screen 1000 (see FIG. 10).

A selling-status display process procedure of the selling status display apparatus 100 is described next.

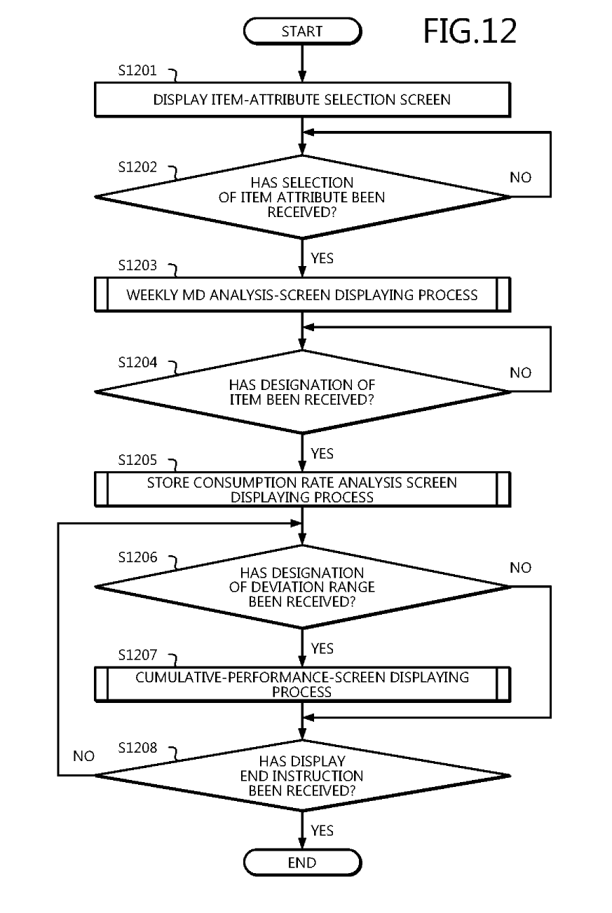

FIG. 12 is a flowchart depicting an example of the selling-status display process procedure of the selling status display apparatus 100. In the flowchart of FIG. 12, first, the selling status display apparatus 100 displays the item-attribute selection screen 700 on the client apparatus 201 (step S1201).

Next, the selling status display apparatus 100 determines whether selection of an item attribute of an item to be subject to analysis concerning the selling status has been received (step S1202). The selling status display apparatus 100 waits for reception of the selection of an item attribute (step S1202: NO).

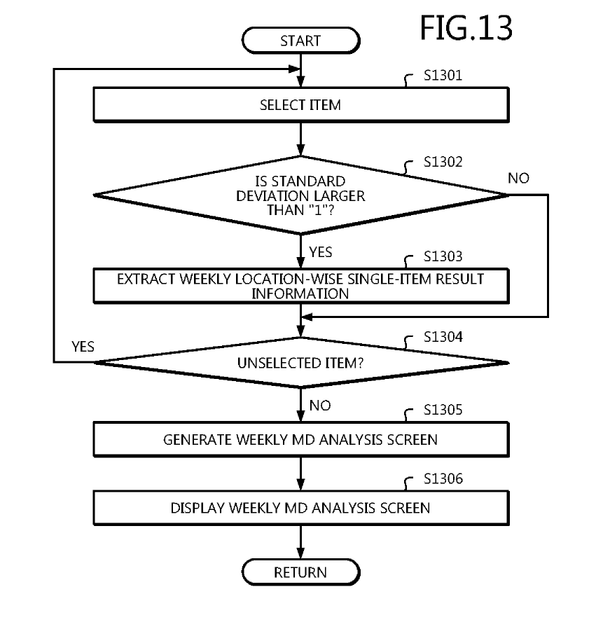

When the selection of the item attribute is received (step S1202: YES), the selling status display apparatus 100 performs a weekly MD analysis-screen displaying process (step S1203). A specific process procedure of the weekly MD analysis-screen displaying process is described later with reference to FIG. 13.

Next, the selling status display apparatus 100 determines whether designation of the item to be subject to analysis concerning the selling status has been received (step S1204). The selling status display apparatus 100 waits for reception of the designation of the item (step S1204: NO).

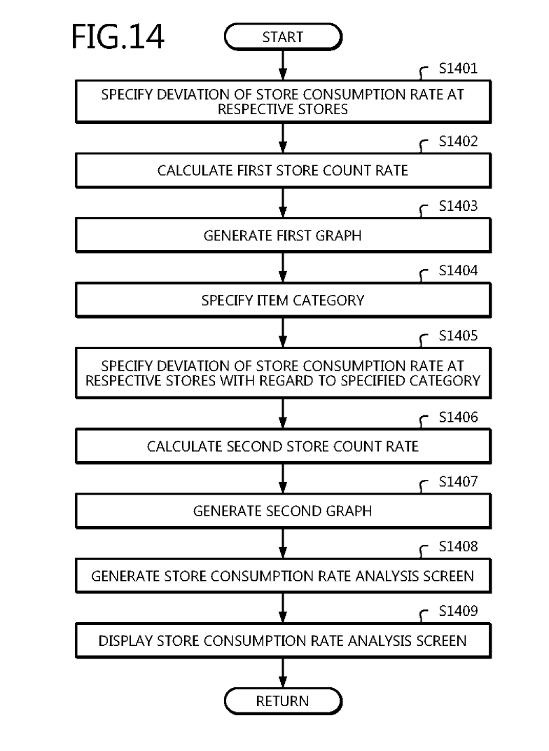

When the designation of the item is received (step S1204: YES), the selling status display apparatus 100 performs a store consumption rate analysis screen displaying process (step S1205). A specific process procedure of the store consumption rate analysis screen displaying process is described later with reference to FIG. 14.

Next, the selling status display apparatus 100 determines whether designation of a deviation range among predetermined deviation ranges has been received (step S1206). If no designation of a deviation range has been received (step S1206: NO), the selling status display apparatus 100 transitions to step S1208.

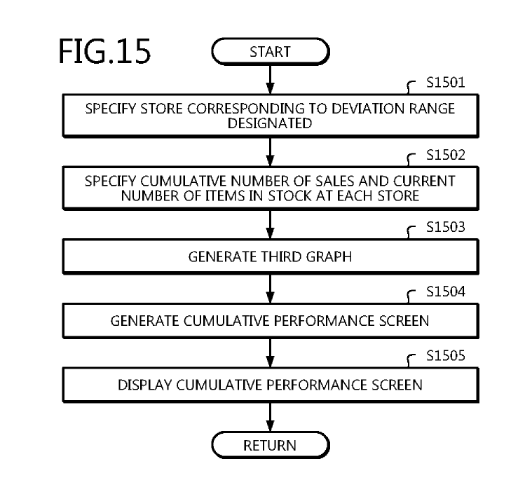

On the other hand, when designation of a deviation range has been received (step S1206: YES), the selling status display apparatus 100 performs a cumulative performance screen displaying process (step S1207). A specific process procedure of the cumulative performance screen displaying process is described later with reference to FIG. 15.

Next, the selling status display apparatus 100 determines whether a display end instruction of various screens has been received (step S1208). The display end instruction of various screens is given by a user operation input on the client apparatus 201, and is notified to the selling status display apparatus 100 from the client apparatus 201.

If a display end instruction of various screens has not been received (step S1208: NO), the selling status display apparatus 100 returns to step S1206. On the other hand, if a display end instruction of various screens has been received (step S1208: YES), the selling status display apparatus 100 ends the display of various screens and a series of operations in the flowchart is ended.

Consequent to this processing, according to the user operation input, various screens (the weekly MD analysis screen, the store consumption rate analysis screen, and the cumulative performance screen) may be displayed on the client apparatus 201.

Next, a specific process procedure of the weekly MD analysis-screen displaying process at step S1203 depicted in FIG. 12 is described.

FIG. 13 is a flowchart depicting an example of a specific process procedure of the weekly MD analysis-screen displaying process. In the flowchart of FIG. 13, first, the selling status display apparatus 100 refers to the item attribute table 500 to select an item specified from an item attribute selected at step S1202 depicted in FIG. 12 (step S1301).

Next, the selling status display apparatus 100 refers to the store consumption rate table 600 and, with regard to the selected item, determines whether the standard deviation of the store consumption rate at the respective stores is larger than “1” (step S1302). If the standard deviation of the store consumption rate at the respective stores is less than “1” (step S1302: NO), the selling status display apparatus 100 transitions to step S1304.

On the other hand, if the standard deviation of the store consumption rate at the respective stores is larger than “1” (step S1302: YES), the selling status display apparatus 100 extracts, from the weekly location-wise single-item performance DB 240, with regard to the selected item, weekly location-wise single-item result information indicating the weekly due stock quantity, the quantity of items received, the amount of net sales, and the quantity of store-stock transition at the respective stores (step S1303).

Next, the selling status display apparatus 100 determines whether there is an unselected item among specified items from the selected item attribute (step S1304). If there is an unselected item (step S1304: YES), the selling status display apparatus 100 returns to step S1301.

On the other hand, if there is no unselected item (step S1304: NO), based on the extracted weekly location-wise single-item result information, the selling status display apparatus 100 generates screen information of the weekly MD analysis screen (step S1305). Subsequently, by transmitting the generated screen information to the client apparatus 201, the selling status display apparatus 100 displays the weekly MD analysis screen on the client apparatus 201 (step S1306), and then returns to the step where the weekly MD analysis-screen displaying process is called up.

Consequent to this processing, on the item attribute selection screen, among the items specified from the selected item attribute, items having a standard deviation of the store consumption rate at respective stores larger than “1”, that is, items having a certain degree of variation in the selling statuses among stores, are displayed such that these items may be listed and designated.

Next, a specific process procedure of the store consumption rate analysis screen displaying process at step S1205 depicted in FIG. 12 is described.

FIG. 14 is a flowchart depicting an example of a specific process procedure of the store consumption rate analysis screen displaying process. In the flowchart of FIG. 14, the selling status display apparatus 100 refers to the store consumption rate table 600, and with regard to items designated at step S1204 depicted in FIG. 12, specifies a deviation of the store consumption rate at the respective stores (step S1401).

Next, with regard to each predetermined deviation range, the selling status display apparatus 100 calculates a first store count rate corresponding to the predetermined deviation range (step S1402). Subsequently, with regard to each predetermined deviation range, the selling status display apparatus 100 generates a first graph representing a first store count rate corresponding to the predetermined deviation ratio (step S1403).

Thereafter, by referring to the item attribute table 500, the selling status display apparatus 100 specifies an item category to which a designated item belongs (step S1404). Subsequently, the selling status display apparatus 100 refers to the store consumption rate table 600 to specify a deviation of the store consumption rate at respective stores with regard to the specified category (step S1405).

Next, with regard to each predetermined deviation range, the selling status display apparatus 100 calculates a second store count rate corresponding to the predetermined deviation range (step S1406). Subsequently, the selling status display apparatus 100 generates for each predetermined deviation range, a second graph representing the second store count rate corresponding to the predetermined deviation range (step S1407).

Next, based on the generated first and second graphs, the selling status display apparatus 100 generates screen information of the store consumption rate analysis screen (step S1408). Subsequently, by transmitting the generated screen information to the client apparatus 201, the selling status display apparatus 100 displays the store consumption rate analysis screen on the client apparatus 201 (step S1409), and then returns to the step where the store consumption rate analysis screen displaying process is called up.

Consequent to this process, the first graph related to items designated on the weekly MD analysis screen and the second graph related to the item category to which the item in question belongs may be displayed simultaneously.

Next, a specific process procedure of the cumulative performance screen displaying process at step S1207 depicted in FIG. 12 is described.

FIG. 15 is a flowchart depicting an example of a specific process procedure of the cumulative performance screen displaying process. In the flowchart of FIG. 15, first, the selling status display apparatus 100 refers to the store consumption rate table 600 to specify a store corresponding to the deviation range designated at step S1206 depicted in FIG. 12 (step S1501).

Next, the selling status display apparatus 100 refers to the location-wise single-item performance DB 230 and the location-wise stock DB 250, and with regard to a designated item, specifies the cumulative number of sales and the current number of items in stock at each of specified stores (step S1502). Thereafter, with regard to the designated item, the selling status display apparatus 100 generates a third graph representing the cumulative number of sales and the current number of items in stock at each of the specified stores (step S1503).

Next, based on the generated third graph, the selling status display apparatus 100 generates screen information of a cumulative performance screen (step S1504). Subsequently, by transmitting the generated screen information to the client apparatus 201, the selling status display apparatus 100 displays the cumulative performance screen on the client apparatus 201 (step S1505), and then returns to the step where the cumulative performance screen displaying process is called up.

Consequent to this process, with regard to items designated on the weekly MD analysis screen, the cumulative number of sales and the current number of items in stock at respective stores corresponding to the deviation ranges designated on the store consumption rate analysis screen may be displayed as these numbers are shown in a graph.

As described above, according to the selling status display apparatus 100 of the present embodiment, with regard to a designated item, when a first graph representing the selling status at each store or variation in sales among stores is displayed, an item category to which the designated item belongs may be specified. Further, according to the selling status display apparatus 100, with regard to the specified item category, by generating a second graph representing the selling status at each store or variation in sales among stores, the second graph may be displayed simultaneously with the first graph.

Thus, when the selling status at each store or variation in sales among stores is checked with regard to a designated item, the selling status at each store or variation in sales among the stores may be determined at the same time for other items in the item category to which the concerned item belongs.

According to the selling status display apparatus 100, with regard to a designated item, based on the variation of the store consumption rate at respective stores, the first graph representing the first store count rate corresponding to the predetermined deviation range in question may be generated for each predetermined deviation range. Thus, it is possible to present the first graph by which variation in sales among stores may be determined with regard to the designated item, enabling determination of the necessity of conducting operations such as inter-store transfer and changing selling prices to be facilitated.

According to the selling status display apparatus 100, for each predetermined deviation range, the second graph representing the second store count rate concerning a specified item category and corresponding to the concerned predetermined deviation range may be generated based on the deviation of the store consumption rate at respective stores. Thus, it is possible to present the second graph by which variation in sales among stores may be determined with regard to the item category to which a designated item belongs, and with regard to other items belonging to the item category in question, determination of the necessity of conducting operations such as inter-store transfer and changing selling prices may be facilitated.

According to the selling status display apparatus 100, upon designation of a deviation range among predetermined deviation ranges, the third graph representing the cumulative number of sales and the current number of items in stock at respective stores corresponding to the designated predetermined deviation range may be displayed with regard to a designated item. Thus, among the stores corresponding to the designated deviation range, the third graph is displayed with regard to the designated item such that stores where the number of items in stock is less due to good sales performance and stores where the number of items in stock is large due to poor sales performance may be distinguished.

According to the selling status display apparatus 100, when designation of an item is received, display is such that predetermined items for which a standard deviation of the store consumption rate at respective stores is larger than a predetermined value may be designated. Thus, when designation of an item to be subject to analysis concerning the selling status is received, display is made such that items having a certain degree of variation in the selling statuses among stores may be listed and designated.

According to the selling status display apparatus 100, when designation of an item is received, the store consumption rate at all stores may be also displayed with regard to predetermined items for which the standard deviation of the store consumption rate at respective stores larger than a predetermined value. Thus, it is possible to present an index for determining the comprehensive sales performance at all stores where the predetermined items received are sold.

As described above, according to the selling status display apparatus 100, it is possible to reduce the time and labor when ascertaining the selling status of each item at respective stores. For example, in the apparel industry, there are many seasonal items and the fashion trend changes every year, so that it is desirable to sell out the items received each season at the end of the season. According to the selling status display apparatus 100, with regard to items for each season, planning of operations such as inter-store transfer and changing selling prices is facilitated to achieve the sale of stock at the end of the season.

The selling status display method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

However, in the conventional technique, much time and labor may be consumed in ascertaining the selling statuses of items. For example, with respect to items sold at multiple stores, it takes much time and labor to manually check the number of sales and the number of items in stock at each store to determine the selling status at each store and variation in sales among these stores.

According to an aspect of the present invention, ascertaining the selling status may be supported.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A selling status display method comprising:
automatically specifying, when a first graph representing a selling status at each store or a variation in sales among stores is generated and displayed with regard to a designated item, an item category to which the designated item belongs;
generating, by a computer, a second graph representing a selling status at each store or a variation in sales among stores with regard to the specified item category; and
displaying the second graph and the first graph.

2. The selling status display method according to claim 1, further comprising
generating, by the computer and for each predetermined deviation range, the first graph representing a count of stores corresponding to the deviation range, the first graph being generated with regard to the designated item and based on a deviation of a store consumption rate indicating a rate of a number of sales with respect to a number of items received at each of the stores, wherein
the generating the second graph include generating for each of the predetermined deviation ranges, the second graph representing a count of stores corresponding to the deviation range, the second graph being generated with regard to the specified item category and based on the deviation of the store consumption rate indicating the rate of the number of sales with respect to the number of items received at each of the stores.

3. The selling status display method according to claim 2, further comprising:
displaying, by the computer and with regard to the designated item, a third graph representing at least any one of the number of sales and the number of items in stock at respective stores corresponding to the designated deviation range, in response to designation of the deviation range among the predetermined deviation ranges.

4. The selling status display method according to claim 1, further comprising
displaying, by the computer, predetermined items for which a value indicating a degree of variation in selling statuses among the stores is larger than a predetermined value, the computer displaying the predetermined items so as to enable designation when designation of an item is received.

5. The selling status display method according to claim 4, wherein
the displaying of the predetermined items includes further displaying with regard to the predetermined items, a store consumption rate indicating a rate of a number of sales with respect to a number of items received at all stores.

6. The selling status display method according to claim 1, further comprising:
generating, by the computer, the first graph representing a number of sales at each of the stores with regard to the designated item, wherein
the generating the second graph includes generating the second graph representing a number of sales at each of the stores with regard to the specified item category.

7. A selling status display apparatus comprising:
a processor configured to:
automatically specify, when a first graph representing a selling status at each store or a variation in sales among stores is generated and displayed with regard to a designated item, an item category to which the designated item belongs;
generate a second graph representing a selling status at each store or a variation in sales among stores with regard to the specified item category; and
display the second graph and the first graph.

8. A non-transitory, computer-readable recording medium storing therein a selling status display program that causes a computer to execute a process comprising:
automatically specifying, when a first graph representing a selling status at each store or a variation in sales among stores is generated and displayed with regard to a designated item, an item category to which the designated item belongs;
generating a second graph representing a selling status at each store or a variation in sales among stores with regard to the specified item category; and
displaying the second graph and the first graph.
